(19) United States
(12) Patent Application Publication
(10) Pub. No.: US 2007/0292315 A1
(43) Pub. Date: Dec. 20, 2007

(54) MINI-TRAY FOR SLIDE PROCESSING

(75) Inventors: Kevin Patenaude, Lowell, MA (US); Robert Sakal, Bolton, MA (US)

Correspondence Address: VISTA IP LAW GROUP LLP, 12930 Saratoga Avenue, Suite D-2, Saratoga, CA, 95070, US

(73) Assignee: Cytyc Corporation, Marlborough, MA (US)

(21) Appl. No.: 11/424,611

(22) Filed: Jun. 16, 2006

(51) Int. Cl. B01L 3/00

(52) U.S. Cl. 422/102

(57) ABSTRACT

Disclosed herein is a carrier for holding various objects used in the processing of biological samples, including a vial, a filter, and a slide. Also disclosed are methods of using the carrier with an automated sample processor.

### FIELD OF THE INVENTION

The present invention relates to the field of automated processing of biological slides and, more particularly, to trays used for holding a biological sample and the slide, prior to and during processing.

### BACKGROUND

Several automated sample processors are known in the art for the preparation of slides with cells taken from biological specimen. For example, U.S. Pat. Nos. 5,143,627, 5,282,978, and 6,562,299, and U.S. Patent Application Publication Nos. 2003-0207455 A1 and 2003-0207456 A1 describe several of such automated systems.

Most automated sample processors have a location for storing a plurality of blank slides and a separate location for storing a plurality of unused filters. The user provides unique biological samples in a vial. The processor obtains a filter, draws cells from the biological sample, obtains a slide, and deposits the cells on the slide, before the cells are fixed on the slide. Thus, the processor creates a unique one-to-one relationship between the biological sample, the filter, and the slide.

If the user needs to insert a sample outside of the regular queue of the samples in the processor, or if the user needs to insert a sample requiring a different test, and therefore, a different filter, some confusion is created as to the exact location of the slide prepared from the out-of-queue sample. Also, there is some difficulty in inserting a different filter in the middle of a run and making sure that the correct filter is used with the correct sample. Therefore, a need exists in the art for a process that allows the user to insert a sample in the middle of a process run, and yet ensure a correct chain of title.

### SUMMARY

Embodiments of the invention include a carrier for holding various objects used in the processing of biological samples, including a vial, a filter, and a slide. Further embodiments are directed to methods of using the carrier with an automated sample processor.

### BRIEF DESCRIPTION OF THE DRAWINGS

In the following description, various embodiments of the present invention are described with reference to the following drawings, in which like reference characters generally refer to the same parts throughout the different views, and in which:

FIG. 1 depicts one embodiment of the carrier of the present invention, having a location for a vial, a filter, and a slide.

FIG. 2 depicts one embodiment of the carrier of the present invention, showing a vial, a filter, and a slide in their respective locations on the carrier.

### DETAILED DESCRIPTION OF THE ILLUSTRATED EMBODIMENTS

Embodiments of the invention are described below. It is, however, expressly noted that the invention is not limited to these embodiments, which are provided for purposes of illustration, and that modifications that are apparent to the person skilled in the art and equivalents thereof are also included.

The carrier disclosed herein is suited for use with ThinPrep® TP2000 (Cytyc Corp.) or ThinPrep® TP3000 (Cytyc Corp.). However, the carriers disclosed herein can be used with any of the processors currently on the market or later developed. The carriers of the disclosed embodiments of the invention provide a novel method of retaining the unique relationship between a sample vial and a prepared slide, without creating any confusion or doubt as to the correct relationship. While the carriers disclosed herein are best used when a new sample is being introduced into a process run already in progress, certain embodiments of the invention include the use of the carriers disclosed herein for introducing all of the samples being processed by a processor.

Thus, in the first aspect, the invention relates to a carrier for slide processing, comprising a location configured to hold a vial; a location configured to hold a slide; and a location configured to hold a filter.

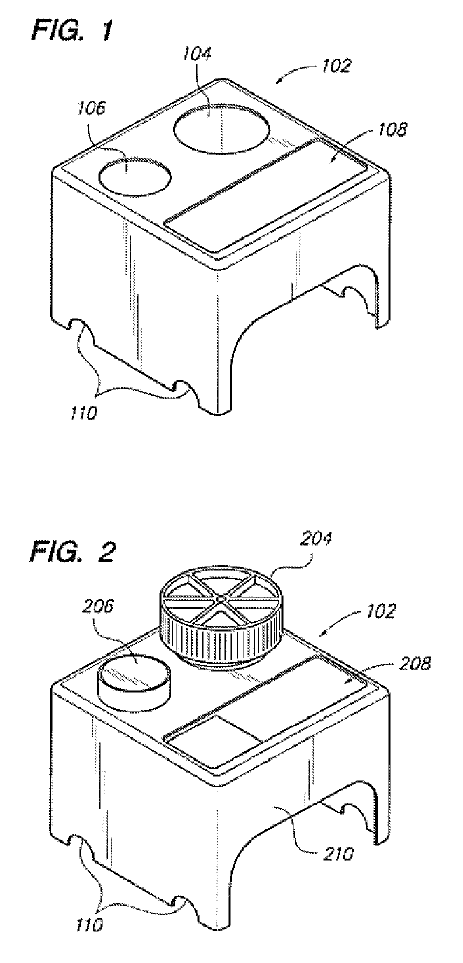

FIG. 1 depicts one embodiment of the carrier disclosed herein. The carrier 102 comprises a location 104 configured to hold a vial. This location 104 can be a hole in the carrier 102. The hole 104 can have a solid bottom, or the bottom can be open. The carrier 102 also comprises a location 106 configured to hold a filter. In some embodiments, the filter comprises a cylindrical tube with one open end and one end covered with a membrane. The cylindrical tube can be configured to fit an aspirator on a ThinPrep® TP2000 or ThinPrep® TP3000 device. The carrier 102 also comprises a location 108 for holding a microscope slide. The slide can be a glass slide or a plastic slide. In some embodiments, the slide is a conventional slide used for preparing biological samples and viewing them through a microscope.

In some embodiments, such as the one shown in FIG. 1, the carrier 102 further comprises indentations 110 on two opposing sides. The indentations, which can be accompanied by other features on the carrier 102, such as grooves, notches, solid bars running along the length or width of the carrier 102, and the like, are configured to fit moving parts within the automated processor. In these embodiments, the user places the carrier 102 in a first location within the automated processor. The processor then automatically takes the tray to a second location for processing the sample. Once the automated processor has completed its process, the carrier 102 is either returned to the first location, or alternatively to a third location within the automated processor, to be removed by the user.

While FIG. 1 shows one configuration of the locations 104, 106, and 108 within the carrier 102, those of skill in the art recognize that other configurations of these locations are possible. The scope of the invention is not limited to the configuration of locations shown in FIG. 1, and also includes all manners of placing these locations on the carrier 102.

In another aspect aspect, the invention relates to a carrier for slide processing, comprising a location configured to hold a vial and a location configured to hold a slide.

In yet another aspect, the invention relates to a carrier for slide processing, comprising a location configured to hold a vial and a location configured to hold a filter.

In still another aspect, the invention relates to a carrier for slide processing, comprising a location configured to hold a slide and a location configured to hold a filter.

FIG. 2 depicts an embodiment of the carrier disclosed here, showing the vial 204 located within the location 104, the filter 206 located within the location 106, and the slide 208 located within the location 108. The particular embodiment shown in FIG. 2 is also directed to an embodiment of the carrier 102 where there is a finger access 210 for easy removal of the slide 208 by the user. Other embodiments of the carrier 102, such as the one depicted in FIG. 1, do not feature the finger access 210.

In some embodiments, the vial 204 is configured to hold a biological sample. Thus, the vial 204 comprises a container and a lid, where medical personnel obtain the biological sample and put in the vial 204, cap it with the lid, and send it to a laboratory for further processing. The biological sample can be a sample obtained during a cervical examination, urine, blood, saliva, stool, or other tissue.

In some embodiments, the filter 206 comprises a membrane connected to a cylindrical member. The filter 206 is configured to have the biological sample aspirated through the membrane, thereby causing cells within the biological sample to adhere to the membrane. The membrane is also configured to have the adhered cells transferred to the slide 208.

In some embodiments, such as the one shown in FIG. 2, the vial 204 sits within the location 104 such that the cap of vial 204 stays above the top surface of the carrier 102. In other embodiments, the vial 204, including its cap, sink within the carrier 102 such that no portion of the vial 204 raises above the top surface of the carrier 102. In some of these embodiments, the carrier 102 comprises means for removing the vial 204, such as depressions on the top surface of the carrier 102 where a mechanical arm, or the like, can reach the vial cap and pull the vial 204 out of the locations 104, or the location 104 has an open bottom where a mechanical arm, or the like, can push the vial 204 up and out of the location 104.

In some aspects, the carrier disclosed herein is used to provide a one-to-one relationship between a biological sample and a prepared slide. In some embodiments, the automated processor, such as the ThinPrep® TP3000 device, is programmed to process a number of biological samples, located at a sample location within the processor. The processor also has a plurality of unused filters and unused slides for the processing. The device obtains a biological sample, uncaps the vial, obtains a filter and attaches the filter to an aspirator within the processor, aspirates some of the biological sample through the filter, such that a plurality of cells adhere to the membrane of the filter, obtains a slide, and contacts the membrane with the slide so that the plurality of the cells are transferred to the slide. The slide is then fixed and labeled. The filter is discarded, and the vial and the slide are put in output trays.

In some embodiments, it is desired that a sample be processed outside of the normal queue of the samples within the processor, either due to a rush, or because the biological sample is of a different kind than the samples in the queue (for example, the processor is processing a plurality of cervical samples and the user desires to process a urine sample). In certain embodiments, the user can interrupt the normal processing run and place the carrier 102 in the processor. The processor then moves the carrier 102 to a second location in the processor, where the vial 204 is removed and uncapped, the filter 206 is attached to the aspirator, cells are adhered to the membrane and transferred to the slide 208. The vial 204 and the slide 208, which can be labeled at this time, are returned to the carrier 102. In some embodiments, the filter 206 is also returned to the carrier 102. In other embodiments, the filter 206 is discarded. The carrier 102 is then removed from the processor. The user would then be in the possession of a tray containing a vial 204 with the biological sample, and a slide 208 having cells obtained from the same biological sample in the vial 204. There would be no doubt as to the one-to-one relationship between the sample in vial 204 and the smear on slide 208. In some embodiments, the user can run multiple samples using a multiple carriers 102. The processor is then allowed to continue with the normal processing run.

Thus, in another aspect, disclosed herein is a method of processing a biological sample in an automated processor, comprising:
obtaining a carrier comprising:
   a vial comprising a biological sample in a first location on the carrier;
   a slide, such as a microscope slide, in a second location on the carrier; and
   a filter having a membrane in a third location on the carrier;
removing the vial from the carrier;
placing the vial within the automated processor;
removing the filter from the carrier;
attaching the filter to an aspirator within the automated processor;
adhering a plurality of cells of the biological sample to the membrane of the filter;
transferring the plurality of cells to the slide; and
replacing the vial in the carrier.

In some embodiments, the user stops or interrupts an ongoing automated process within the automated processor prior to the placing the vial step in the above method. In certain embodiments, the user restarts the automated process subsequent to the replacing the vial step.

In other embodiments, the user prepares a plurality of carriers 102, each having a vial 204 of biological sample and a slide 208 and a filter 206. The user can feed the plurality of the carriers 102 to the automated processor, either manually or automatically. In these embodiments, the automated processor does not obtain a slide and a filter from a stockpile of the same within the automated processor. An advantage of the method of these embodiments is that the user can insert different samples without pausing the automated process. Pausing the automated process can take some time to allow the processor to reset itself. Bypassing the pause can reduce the amount of time spent on sample processing.

In certain embodiments, the carriers disclosed herein are used with a processor, such as the ThinPrep® TP2000 device. In these embodiments, some of the steps enumerated in the above method are conducted manually.

In some embodiments, the automated processor labels the slides 208 automatically using at least one identifier. The identifier can be the name of the patient, the patient's unique number (such as medical record number or social security number), sample number, the name and location of the medical facility, the name of the medical care provider who obtained the sample, etc. Preferably, the same identifier appears on the vial 204 having the biological sample. In other embodiments, the user labels the slides 208 prior to inserting the carrier 102 into the automated processor. Certain laboratories have their own unique method of labeling the slides. An advantage of the methods disclosed herein is that it allows the laboratories to retain their labeling format on the slides, without having to change their format to fit the limitations of the automated processor.

It should be understood by those skilled in the art that the steps in the above-described method may be practiced in various different orders in alternative embodiments. Further, the foregoing embodiments are to be considered in all respects illustrative rather than limiting of the invention, which is only limited by the following claims and their equivalents.

What is claimed is:

1. A carrier for slide processing, comprising
a location configured to hold a vial, said vial configured to hold a biological sample;
a location configured to hold a slide; and
a location configured to hold a filter;
wherein said filter comprises a membrane connected to a cylindrical member, said filter configured to have said biological sample aspirated through said membrane, thereby causing cells within said biological sample to adhere to said membrane, and said membrane is configured to have said adhered cells transferred to said slide.

2. The carrier of claim 1, further comprising means for moving said carrier through an automated processor.

3. The carrier of claim 1, further comprising a finger access indentation underneath said slide.

4. The carrier of claim 1, wherein said location for holding said vial is of such depth such that the cap of said vial stays above the top surface of said carrier when said vial is positioned inside said location for holding said vial.

5. A method of processing a biological sample in an automated processor, comprising:
obtaining a carrier comprising:
a vial comprising a biological sample in a first location on said carrier;
a slide in a second location on said carrier; and
a filter having a membrane in a third location on said carrier;
removing said vial from said carrier;
placing said vial within said automated processor;
removing said filter from said carrier;
attaching said filter to an aspirator within said automated processor;
adhering a plurality of cells of said biological sample to said membrane of said filter;
transferring said plurality of cells to said slide; and
replacing said vial in said carrier.

6. The method of claim 5, further comprising replacing said filter in said carrier.

7. The method of claim 5, further comprising discarding said filter.

8. The method of claim 5, further comprising stopping the automated process of said automated processor prior to said placing said vial step.

9. The method of claim 8, further comprising restarting said automated process subsequent to said replacing said vial step.

10. The method of claim 5, further comprising marking said slide with at least one identifier.

11. The method of claim 5, further comprising replacing said slide in said carrier after said plurality of cells are transferred from said filter to said slide.
